(19) United States
(12) Patent Application Publication
(10) Pub. No.: US 2010/0211427 A1
(43) Pub. Date: Aug. 19, 2010

(54) METHODS AND SYSTEMS FOR BROKERING UNDER-UTILIZED AMENITIES AND ASSETS OF PRIVATE CLUBS

(76) Inventors: McRedmond Morelli, Mercer Island, WA (US); Michael A. Hall, Bexley, OH (US); Corey Jeffries, Granville, OH (US)

Correspondence Address: WILSON, SONSINI, GOODRICH & ROSATI, 650 PAGE MILL ROAD, PALO ALTO, CA, 94304-1050, US

(21) Appl. No.: 12/709,322

(22) Filed: Feb. 19, 2010

Related U.S. Application Data
(60) Provisional application No. 61/153,936, filed on Feb. 19, 2009.
(60) Provisional application No. 61/167,069, filed on Apr. 6, 2009.

(51) Int. Cl. G06Q 30/00; G06Q 10/00; G06Q 50/00; G06Q 20/00

(52) U.S. Cl. 705/8; 705/14.51; 705/27

(57) ABSTRACT

Methods and systems for brokering under-utilized amenities and assets of private clubs. In tougher economic times, private clubs may face economy-related membership attrition and overall revenue shortfalls. A marketplace for trading available assets and amenities among a controlled audience in a simple, orderly manner for private clubs may help private clubs endure economic downturns. Revenue may be generated from the sale of mailing lists of members, percentages of asset sales, related amenity sales, or sales of other services reserved or made through the site. In addition, a network and community of committed, affluent subscribers may benefit from such a marketplace through forums, chats, discussions and blogs to further foster their relationships. Vendors seeking to make targeted advertisements may also find such a community beneficial.

### CROSS-REFERENCE

This application claims the benefit of U.S. Provisional Application No. 61/153,936, filed Feb. 19, 2009 and U.S. Provisional Application No. 61/167,069, filed Apr. 6, 2009, which applications are incorporated herein by reference in their entirety.

### BACKGROUND

Computers and the Internet have transformed the private amenity and asset management businesses in many ways. For many private clubs, computers assist in back office functions such as accounting and inventory control. For example, on certain private golf courses, computers assist in such back office functions. In addition, computerized tee sheet management systems have enabled golf courses to automate their core tee time booking functions, though some courses still employ paper-and-pencil “tee sheets”.

With the commercial development of the Internet, web-based brokering and management systems have been introduced and adopted by many private clubs which offer its members certain amenities and assets. For example, a private golf club may offer its members tee time reservations. The advantage of many web-based management systems is that they allow any private club with Internet access to be able to manage its assets and amenities offered online. For example, with respect to public golf courses, online tee time “hubs” such as the hub at www.golfnow.com have emerged to offer available tee times from multiple courses, so that golfers can view, select and reserve tee times from multiple public courses at a single destination web site. One of the benefits is that the customer traffic to hubs such as www.golfnow.com is far greater than the traffic that any individual course could attract to its own standalone site.

Still, public players face the difficulties imposed by not having access to certain private golf courses, even though tee times may be available. Members of other clubs may face similar problems. What is needed is an effective way to utilize the assets and amenities offered by private clubs, while creating benefits to both private clubs and members alike.

### SUMMARY OF INVENTION

The invention provides methods for brokering under-utilized amenities and assets of private clubs. Various aspects of the invention described herein may be applied to any of the particular applications set forth below. The invention may be applied in a standalone system or as a component of an integrated software solution. The invention can be optionally integrated into existing business and processes seamlessly. It shall be understood that different aspects of the invention can be appreciated individually, collectively or in combination with each other.

One aspect of the present invention provides a method for utilizing assets or amenities of private clubs (or other type of organization). The method involves displaying available assets or amenities from a multitude of private clubs. Reservations of such assets may be made, and fees may be charged for making such reservations. Additionally, a membership fee or booking fee may be charged for being able to access the available assets or other features of the system.

Unless specifically stated otherwise, as apparent from the following discussions, it is appreciated that throughout the specification, discussions utilizing terms such as “processing,” “computing,” “calculating,” “determining,” or the like, may refer in whole or in part to the action and/or processes of a processor, computer or computing system, or similar electronic computing device, that manipulate and/or transform data represented as physical, such as electronic, quantities within the system's registers and/or memories into other data similarly represented as physical quantities within the system's memories, registers or other such information storage, transmission or display devices. It will also be appreciated by persons skilled in the art that the term “users” referred to herein can be individuals as well as corporations and other legal entities. Furthermore, the processes presented herein are not inherently related to any particular computer, processing device, article or other apparatus. An example of a structure for a variety of these systems will appear from the description below. In addition, embodiments of the present invention are not described with reference to any particular processor, programming language, machine code, etc. It will be appreciated that a variety of programming languages, machine codes, etc. may be used to implement the teachings of the invention as described herein.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

Some of the features of the invention are described as set forth in the following figures and description. A better understanding of the features and advantages of the invention will be obtained by reference to the following detailed description that sets forth illustrative embodiments provided in accordance with the invention.

FIG. 1 illustrates an asset exchange platform in accordance with embodiments of the present invention which may be accessed over the Internet by private clubs, members of private clubs, and other subscribers.

FIG. 2 illustrates an example of a flow chart for a club to post and/or schedule assets in accordance with embodiments of the present invention.

FIG. 3 illustrates an example of a flow chart for a club to add, update or edit posted assets or criteria in accordance with embodiments of the present invention.

FIG. 4 illustrates an example of a flow chart of the process clubs may use to post directed assets or cancel booked assets in accordance with embodiments of the present invention.

FIG. 4A illustrates an example of reciprocal network relationships in accordance with embodiments of the present invention.

FIG. 5 illustrates an example of a flow chart for a hosting subscriber to post or direct available assets for other subscribers to reserve, in accordance with embodiments of the present invention.

FIG. 6 illustrates an example of a flow chart for an individual subscriber interacting with the asset exchange platform in accordance with embodiments of the present invention.

FIG. 7 illustrates an example of a flow chart for an individual subscriber to modify or cancel an upcoming asset in accordance with embodiments of the present invention.

FIG. 8 shows various membership services for members of private clubs or other individual subscribers that may be made available by the web interface in accordance with embodiments of the present invention.

FIG. 9 shows various membership services for private clubs and other institutional subscribers that may be made available by the web interface in accordance with embodiments of the present invention.

### DETAILED DESCRIPTION OF INVENTION

In the following detailed description, numerous specific details are set forth in order to provide a thorough understanding of the invention. However it will be understood by those of ordinary skill in the art that the invention may be practiced without these specific details. In other instances, well-known methods, procedures and components have not been described in detail so as not to obscure the invention. Various modifications to the described embodiments will be apparent to those with skill in the art, and the general principles defined herein may be applied to other embodiments. The invention is not intended to be limited to the particular embodiments shown and described.

When referring to private clubs herein, it is understood that the various embodiments and examples described herein could also be applied to any type of private or public organization, including any 501(c)(7) organization or any for-profit organization. Such organization may be a private club, which may have members and non-members seeking use of under-utilized assets or amenities offered by the organization. For example, a private club could be a hunting club, a yacht club, an athletic club, a supper club, a tennis club, an auto club, etc. Assets could include any reservations or amenities offered by these clubs including tee time reservations, class reservations, meal reservations, tutoring reservations, tickets for entry to events or locations, etc.

One issue that faces private clubs such as private golf clubs, private hunting clubs, private yacht clubs, etc. is maximizing the utilization of their amenities and assets. For example, private golf clubs face the problem of maximizing tee time utilization. Private clubs generally charge its members dues or other forms of membership fees to use their facilities, assets or other amenities. Being part of a private club means that members can socialize with other members and may use its facilities maintained by the private clubs, in exchange for the financial costs of membership fees or dues. Because of the often high costs of joining or the high membership fees or dues, these private clubs are considered exclusive, and its members an elite crowd.

The downsides of being a member of a private club are that the membership fees or dues are often high, and thus membership is costly and can present a financial burden. Further, while members of private clubs have access to certain assets and amenities of a private club, the experience with a certain club may become repetitive. For example, members of a private golf club would play on the same grounds repeatedly, members of a private yacht club would have access to the same boat slips, etc. In addition, while private clubs present social and business networking opportunities, these opportunities are limited to those who are members to the specific private club.

Managing a private club presents its own set of challenges. For example, for private golf clubs, maintenance costs associated with maintaining a golf course and its grounds are often high, while utilization of that golf course and grounds may be low. Further, while there may be demand from non-members that would like to play on private club's golf courses, it may be difficult to tap into that demand, without sacrificing the interests of a private golf club's paying members. Similar problems with under-utilized assets and amenities can arise with other types of private clubs as well. Embodiments of the current invention present methods for utilizing the demand from non-members who want access to the amenities and assets of certain private clubs, without purchasing a membership to those private clubs. Thus, the membership of a private club may be expanded and revenue increases by utilizing its otherwise under-utilized assets, but without forcing the cost of full membership, and also without sacrificing the appeal and exclusivity of the private club.

In certain cases, public facilities may be offered as an alternative to the private club, however the public facilities may also have significant downsides. For example, playing on municipal or public golf courses, one alternative to the private golf club, while cost effective, may have significant downsides. Using municipal or public golf courses can often result in a crowded experience, and thus playing a round of golf may be time consuming. In addition, because there are lower (or no) fees to play the course and the funding may be more limited, the course may not be as well maintained as certain private golf courses. The social and business opportunities may also be limited.

A significant market opportunity is available to private clubs that can find methods for brokering its under-utilized assets and amenities. For example, a significant market opportunity is available to private golf clubs that can find methods for exploiting unused tee times. Specifically, embodiments of the present invention provide a distinctive marketplace for members of private clubs and non-members to tap the excess supply of certain assets and amenities of private clubs.

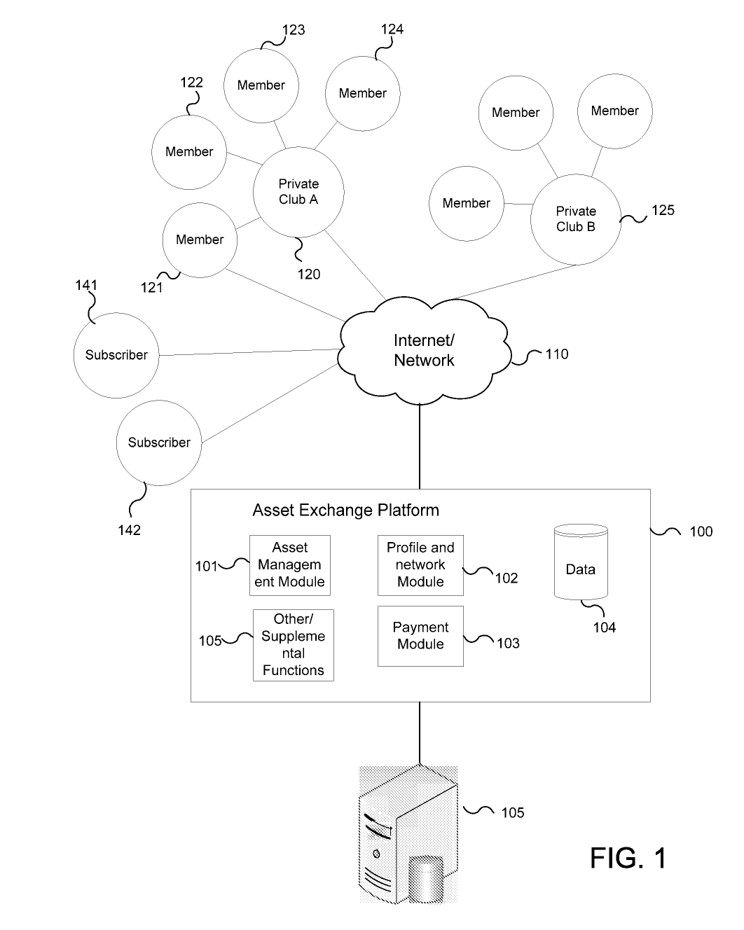

Referring to FIG. 1, in one aspect of the present invention, an asset exchange platform 100 is available over a network such as the Internet 110. Private clubs 120, 125 may utilize the asset exchange platform 100. Members of private clubs 121, 122, 123, 124, etc. may have access to the asset exchange platform 100 over the network or Internet 110 or some other type of network. In addition, other subscribers 141, 142, etc. may also have access to the asset exchange platform 100. These subscribers 141, 142 may pay a subscription fee or booking fee in order to have access to the asset exchange platform 100. Different features of the asset exchange platform 100 may be available at different subscription levels. For example, a limited number of features may be available at a standard membership level and an expanded set of features may be available at a premium membership level. The subscribers 141, 142 may be individuals who do not belong to a private club, for example. In one embodiment, the asset exchange platform may be a tee-time exchange platform and the clubs may be private golf clubs and/or public golf courses.

The asset exchange platform 100 may therefore create a members-only (or subscribers-only), online community comprised of private clubs, members of private clubs and other non-member individuals (for example, avid golfers, avid hunters, avid tennis players, etc.). Thus, the platform 100 may be available to private clubs 120, 125, members of private clubs 121, 122, 123, 124 as well as other subscribers 141, 142 who are not members of private clubs. It should be noted that in certain embodiments, a member of a private club 122 may need to purchase a direct subscription to the interface in order to access the asset exchange platform 100, and is not necessarily a subscriber by virtue of membership with the private club 120. The platform may present individual subscribers with more cost-effective options to obtaining access to certain assets and amenities, along with an endless variety and quality of various assets and amenities from a multitude of private clubs. In addition, because the platform 100 offers and makes available the assets and amenities of private clubs, assets and amenities that would otherwise go unutilized may be utilized. Further, in ways that will be discussed in more detail below, the platform 100 may provide its users with additional opportunities for social and business networking.

The asset exchange platform may include an asset manager module 101 which manages the reservations of certain assets or amenities, a profile and network manager module 102 which manages subscriber's profiles, private club profiles, forums, discussions, chats, statistics that may be captured, target advertising, etc., and a payment module 103 which may handle revenue collection. There may be other supplemental functions 105 as well. Data may be stored in data storage 104. The platform 100 may be coupled with a server and data storage 105. In another embodiment, there may be an asset exchange system 100 (see FIG. 1) which is coupled to a server and data storage 105. Aspects of the systems and methods described herein may be implemented as functionality programmed into any of a variety of circuitry, including microcontrollers with memory, embedded microprocessors, firmware, software, etc. It should be noted that the various functions or processes disclosed herein may be described as data and/or instructions embodied in various computer-readable media. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, email, etc.) over the Internet and/or other computer networks via one or more data transfer protocols (e.g., HTTP, FTP, SMTP, etc.). When received within a computer system via one or more computer-readable media, such data and/or instruction-based expressions of components and/or processes under the systems and methods may be processed by a processing entity (e.g., one or more processors) within the computer system in conjunction with execution of one or more other computer programs.

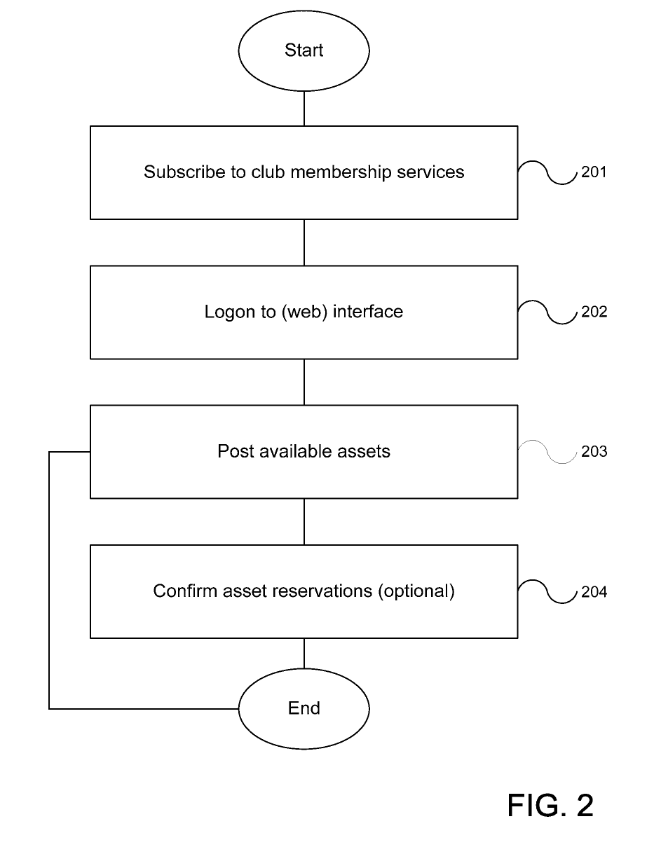

Referring to FIG. 2, another aspect of embodiments of the present invention allow a club subscriber (institutional subscriber) to access an interface and subscribe to membership services 201. By subscribing to club membership services in step 201, new private clubs may become members of the network. The “club” may be a manager of a private club or other organization. In addition, several managers may share one institutional account and use it to logon to the interface 202. Subscribing to the club membership services may include activities such as setting up user names, passwords, or contact information. In addition, each institutional subscriber (or private club) may maintain a profile through the interface, and the club may have the ability to update its profile information which may include information about the club such as the contact information described above or additional information about the club, and various assets and amenities and submitting information about dress codes and codes of conduct, for example.

After accessing the interface, the private club may post assets or amenities that are available for reservations to the system for individual subscribers to review (203). For example, a private golf club may post various available tee times for reservation. Institutional subscribers may place certain qualifications, criteria or requirements for making particular asset reservations. For example, a particular private golf club may require a certain handicap, require that the golfer live within a certain geographic area, require that the golfer has a certain user rating or feedback score, or limit the number of rounds that the golfer may play at the course in any given month, year, lifetime, etc. Subscribers, who meet the various qualifications or requirements for making the particular reservation, may be able to review which assets are posted and make a reservation through the system (as further described below). A private club may then choose to confirm the reservation, perhaps after a review of the subscriber's profile or other qualifications (204). Thus, a private club may maintain the exclusivity of the club by setting various requirements that subscribers must meet in order to make reservations of assets or amenities. The criteria may vary depending on various factors, such as the time of day, day of week, or any other variable as set and managed by the institutional subscriber. In some embodiments, the reservation may be automatically reserved by the individual subscriber, and may not require a step of confirmation by the private club. It can be appreciated that the various criteria that may be required for a subscriber to make a certain reservation of a particular asset are not limited to the particular examples discussed herein, but may include a number of other types of requirements.

In some embodiments of the invention, the institutional subscriber may bundle other incidentals and amenities and offer them with the particular asset. For example, a golf club may offer use of their driving range, a lunch or beverage, or a discounted rental of a golf cart, with certain tee times or rounds. These benefits may encourage golfers or players to reserve certain less popular tee times, thus creating incentives to reserve normally under-utilized assets.

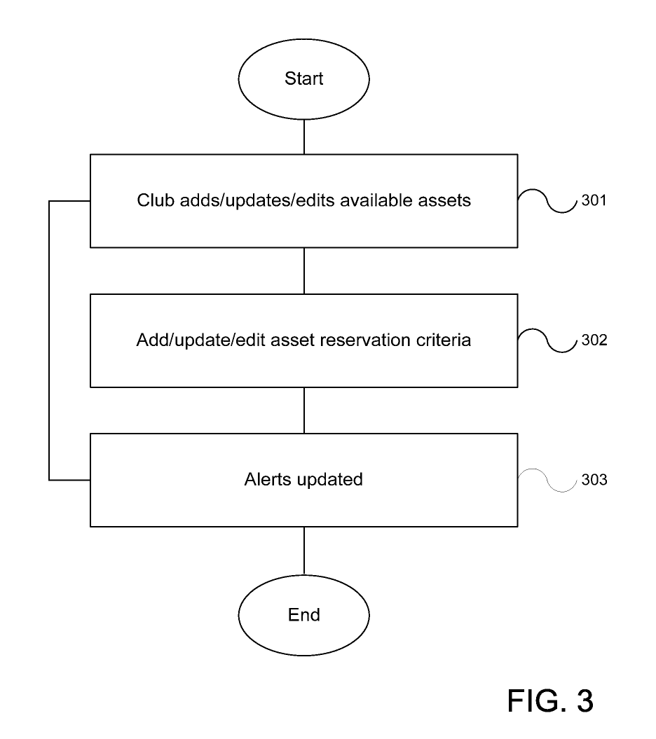

Referring to FIG. 3, a private club (or institutional subscriber) may add available assets or amenities to the database through the interface 301. Such assets or amenities may be available tee times for private golf clubs, available boating slips for private yacht clubs, available court times for private tennis clubs, available rooms for athletic clubs, available skeet course times for hunting clubs, etc. As such assets or amenities are added or made available through the interface, certain subscribers who have notifications in place (as described below) may be alerted to such available assets or amenities 303. In addition, a private club (or institutional subscriber) may be able to update or make changes to the available assets or amenities 301. A private club (or institutional subscriber) may also optionally be able to add, update or make changes to certain criteria for reserving or accessing the asset or amenity 302. For example, as mentioned previously, a private golf club may want to restrict which players may play on the course, which tee times certain golfers or players may schedule, or the number of tee times any one player may reserve within a given week, month or year. There are many variations of the types of restrictions that may be included in such criteria, and any number of restrictions may be applied to any individual or groups of individuals.

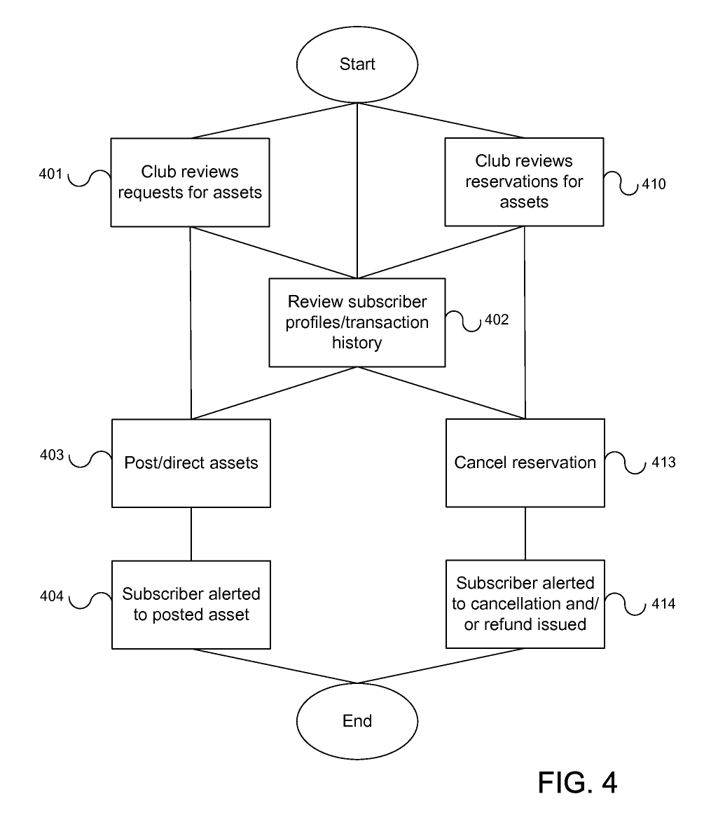

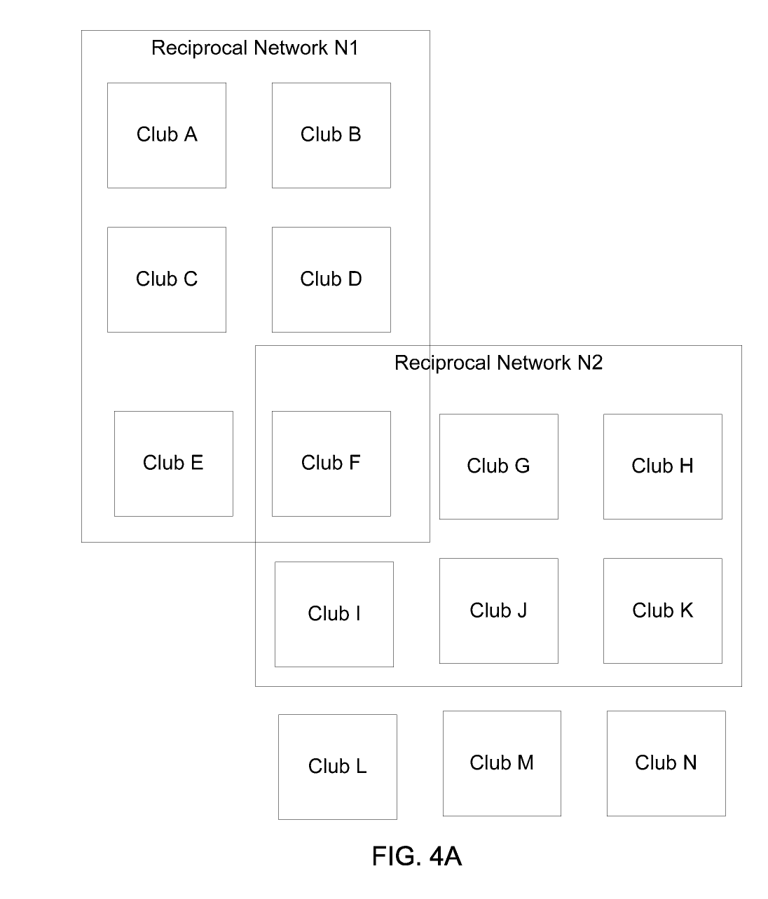

Referring to FIG. 4, a private club (or institutional subscriber) may be able to review open requests submitted by individual subscribers for certain assets or amenities 401. The interface may filter the requests from the individual subscribers such that only open requests for assets or amenities that could apply to the particular private club are displayed in step 401. The club may additionally have the ability to filter the requests for certain assets or amenities in step 401 based on other filters such as the date, day of week, time of day, or region, etc. A club may then review requests from individual subscribers for assets or amenities for a particular region, a particular date, a day of the week, a time of day, or other criteria. In addition, the club may also optionally review the profile or transaction history of the individual subscriber that has submitted the request for the asset in step 402. In step 403, after reviewing the open requests, the club may post assets or amenities that satisfy specific requests in step 403. The individual subscriber may then be alerted to the posted assets in step 404.

For example, an individual subscriber may request a certain room at a private athletic club, a certain class of hotel or timeshare within a private group, a certain tee time at a private golf course, a certain boat slip, etc. The private club may review such requests and then post its assets (such as a room, tee time, boat slip, etc.) and make them available to an individual subscriber. Thus, the systems and methods as presented by the present invention may allow private clubs to “sell” or make available under-utilized assets to both member subscribers and non-member subscribers who meet certain criteria, as set by the private clubs.

A club may also make targeted posts or invitations for its assets or amenities. The club (or institutional subscriber) may browse or review subscriber profiles or transaction history in step 402, and then extend a particular subscriber or group of subscribers personal invitations to access certain assets or amenities. For example, if a certain golfer has a private golf club listed as a “favorite” in his or her profile, the private golf club may want to extend that golfer a personal invitation to play at the course in step 403. That golfer may then be alerted to the posting or invitation in step 404. In some embodiments two or more clubs may establish reciprocal relationships. Thus, private club A may be able to, through the interface, send a personal invitation to all of the members of private club B, inviting the members to access certain assets of club A and attracting new individuals to club A, and vice versa. A private club or institutional subscriber may then be able to take advantage of the resources of the interface to expand its membership or find new members by offering directed or targeted asset or amenity invitations. Thus, the platform can be used to facilitate new relationships (between or amongst private clubs or between private clubs and individual subscribers) by offering assets that are otherwise only available to members of certain private clubs, and making them available to non-member subscribers. It can be appreciated that a particular club or institutional subscriber may choose to extend personal invitations or choose to direct assets based on any number of reasons or criteria. For example, a private golf club may choose to direct its tee times based on criteria such as players of a certain location, handicap, feedback score or rating, etc.

A club may also cancel a previously booked reservation for an asset or amenity and notify individual subscribers of the cancellation. The club may first review a list of booked assets for the particular club in step 410. The club (or institutional subscriber) may optionally review an individual subscriber's profile or transaction history, and may cancel individual bookings or all bookings for a given day in step 413. As the bookings are cancelled, a notification may be sent to the individual subscriber through the interface, as well as through SMS or e-mail or by any other means as the individual subscriber has requested or selected in step 414. In addition, a credit or refund may be issued to the individual subscriber's payment method, if appropriate.

Referring to FIG. 4A, the system may also facilitate reciprocal network relationships among a group of clubs. For example, six clubs A, B, C, D, E, F within a certain geographic location may want to reciprocate and offer assets or amenities to the members of those six clubs. Thus, they may form a reciprocal network N1 to offer its members certain assets or amenities that will not be made available outside of reciprocal network N1 or offer its members certain assets or amenities at a different price than the price offered to subscribers outside of reciprocal network N1. Or, certain assets may be offered within the platform to members of those six clubs A, B, C, D, E, F while other assets (or a subset of those assets) may be offered generally to subscribers of the platform. There may be more than one reciprocal network created and certain clubs, such as Club F, may belong to more than one reciprocal network (e.g., networks N1 and N2). Other clubs L, M, N may not belong to any reciprocal networks, but its members may have access to assets or amenities that are offered generally to subscribers of the platform. The invention is not limited to the particular examples as described herein.

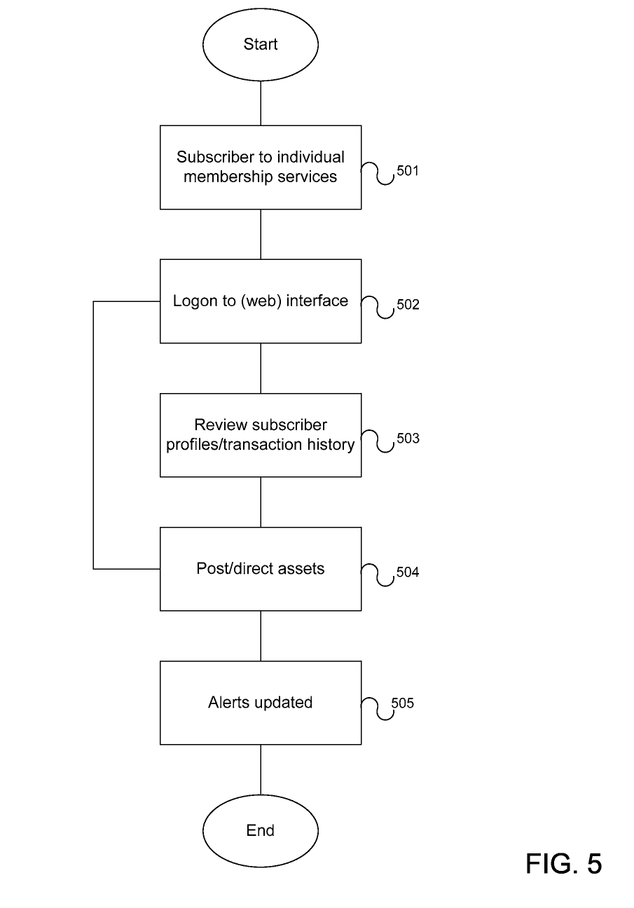

Referring to FIG. 5, another aspect of embodiments of the present invention allows members of a private club (individual subscribers) to post available assets for private clubs to which they are a member. For a private club that is exclusive to its members, individual subscribers who are members of such clubs may be able to post certain assets to allow other non-members to benefit from such assets, through the system. The individual subscriber then may become a “hosting subscriber” by posting assets through the system. For example, an individual golfer who is a member of a private golf club may be able to post certain tee times to allow other non-members to join them for certain rounds, through the system. Thus, a private golf club member may subscribe to certain membership services in step 501. By virtue of the private golfer's membership to a certain private golf club, a subscriber may meet the requirements to enable him to be able to reserve a certain tee time through the system at a private golf club. Alternatively, the private golf club member may reserve the tee time through other means (e.g., over the telephone, at the private club, etc.). For example, the private golf club member (or hosting subscriber) may make a reservation for four people to play at a certain golf course at a certain time. The private golf club member may then logon to the interface in step 502, and post that he or she has three available spots to play a certain round of golf at the private golf club in step 504. Other subscribers may be alerted to this posting via tee time alerts in step 505.

The methods as applied to a private golf club member may be also applied to other members of other types of private clubs as well. For example, an individual with an athletic club membership may be able to make a reservation through the system to reserve a certain club room, by virtue of his or her membership to the athletic club. That member may then logon to the interface in step 502 and post that he or she has six available spots to join him or her in the reserved club room in step 504. Other subscribers may be alerted to this posting via alerts in step 505. Thus, the system enables the brokering of under-utilized amenities by allowing members and subscribers to both post and petition to use such amenities. A non-member can seek to access certain under utilized assets and amenities, and private clubs may seek to sell or utilize such assets and amenities.

The hosting subscriber may also establish criteria for accepting or reserving the posted asset, just as an institutional subscriber may. Thus, for example, in step 504, when the hosting subscriber posts an available tee time for a private golf club, the hosting subscriber may also put criteria on those tee times such as a certain handicap score, or a certain feedback rating for the user, etc. The hosting subscriber may also require that the person who accepts or reserves the tee time must reciprocate the invitation and invite the hosting subscriber onto a different private golf course, on which that person is a member. Similar analogies and examples can apply to other types of private clubs, including private tennis clubs, private yacht clubs, private hunting clubs, etc. The hosting subscriber may also target users with memberships to certain clubs, for example, and by offering up an asset may gain access to another private club membership through the system. In addition, the hosting subscriber may be able to offer personal targeted invitations of assets to certain users. For example, the hosting subscriber may first review and browse subscriber profiles and transaction histories in step 503, and upon finding a suitable subscriber, the hosting subscriber may offer a personal invitation. For example, a hosting subscriber who is a member of a private golf club may offer another golfer a personal invitation to play a certain round of golf with that particular user in step 504, based upon that golfer's profile, history, or other criteria. Thus, it is possible for a hosting subscriber to direct an asset invitation to a particular user.

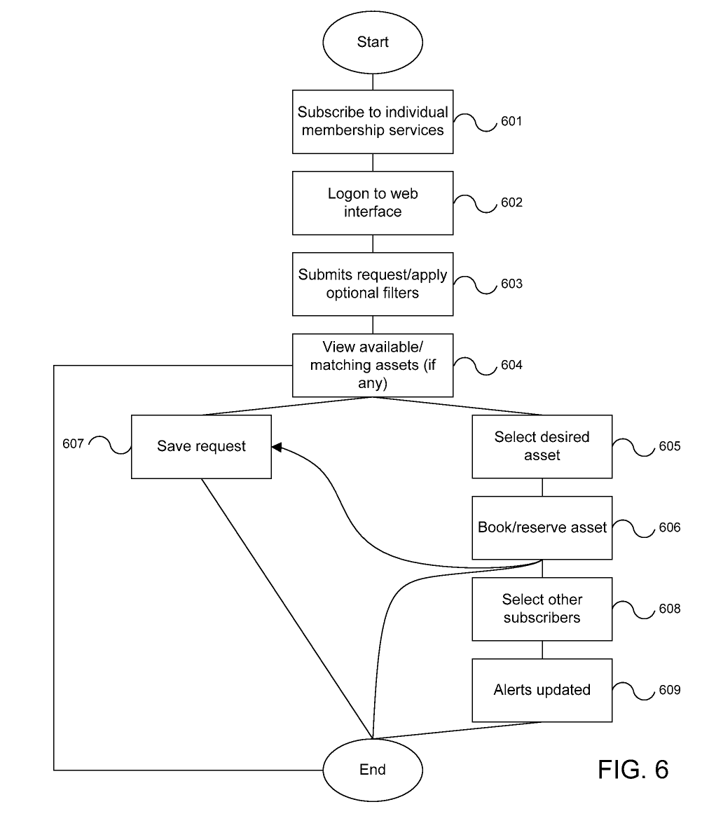

Referring to FIG. 6, another aspect of embodiments of the present invention allow individual subscribers to an online asset exchange platform to reserve assets, or view available assets. In step 601, a user may subscribe to membership services, and in step 602, the user may logon to the interface. The interface may be available over a network such as the Internet, and may be a web-based interface. Because assets may be posted by various types of organizations or institutional subscribers as described above (including different types of entities), the available assets in step 604 may be of varied type, quality, and may have a number of different characteristics. In step 605, the individual subscriber may select a desired asset, and in step 606, an individual subscriber may schedule or reserve available assets.

Subscribing to membership services in step 601 may allow for individual subscribers to join a network, and may include steps of providing demographic and preference information about the individual subscribers or payment of a subscription or membership fee. Subscribing to the membership services may also involve creation of user IDs and passwords and other customary user account setup steps. Individual subscribers may also provide and setup certain profile information. For example, subscribers who are interested in accessing and brokering private golf club tee times may enter information such as a handicap and the handicap system used. The interface may help the golfer calculate a temporary handicap for the golfer based on their typical score, or may connect the golfer to the specified handicap system and verify the golfer's handicap. The golfer may also identify any private golf club memberships, manufacturer preferences for equipment, play speed, etc. The golfer may also be able to include milestones in his or her profile information (e.g., holes in one, favorite courses played, etc.). It can be appreciated that other types of profile information may be entered, depending on the types of assets being utilized. Many of these optional attributes may be added or updated at any time through the interface, and some of the optional attributes may enable individual subscribers to be able to view or reserve certain available assets. For example, a certain private golf club may limit reservations for available tee times to golfers with certain handicap levels, and thus an individual player with a certain handicap X may have access to certain available tee times, while another player with a certain handicap Y would not have access to those same tee times.

An individual subscriber may also submit an open-ended request or search to an asset or amenity with specified attributes in step 603. For example, the user may specify values for a number of attributes including certain clubs, locations, dates, times, etc. After the open-ended request or search has been entered, the database may be queried to determine whether any existing assets match the submitted criteria. If there are matching and available assets, the user may be presented with a list of available assets in step 604, and have the ability to select the desired asset in step 605, and book the available asset in step 606. In addition, the user may be able to save the request in his or her favorites in step 607 so that the user is alerted to matching assets if they are later uploaded by a private club. If there are no matching assets available in step 604, then the individual subscriber may also save the request in step 607 to his or her favorites.

At any point after booking or reserving an asset (for example, in step 606), in any of the embodiments described, an individual subscriber may have the ability to select other members from other users of the interface in step 608, and other subscribers may be alerted to the reservation and request in step 609. Thus, for example, a golfer may be able to find other players to play a round with through the interface. A golfer may select another user in step 608 by browsing the network directory or specifying other users by name, and those other users may be notified of such requests and have the opportunity to accept or reject the requests. Alternatively, in step 606, when booking or reserving the tee time, the user may specify other members of their playing party, or not specify any members at all. The system may alternatively automatically confirm other members of a playing party that are specified, without requiring the other members to accept or reject any requests. The golfer may be required to make a payment in order to reserve the tee time. It can be appreciated the same methods may be applied to other types of assets and clubs.

An individual subscriber may be able to make a specific request for an asset from either a private club (institutional subscriber) or another hosting subscriber (individual subscriber). In step 603, an individual subscriber may submit a certain request to either a private club or a hosting subscriber, and that request may be communicated to either the clubs or hosting subscriber. The request may specify certain criteria such as times, dates, locations, etc. In the event that there are no assets already posted that meet all of the requirements of the request, the request may be saved in step 607 and later fulfilled by a private club or a hosting subscriber.

When an asset is booked, various notifications may be processed. For example, when a particular tee time is booked for a private golf club, all members of the playing party may be sent a notification of the date, time, and location of the round, as well as the code of conduct and dress code for the particular club or location. In addition, an alert may be sent to the club (or institutional subscriber) to notify them of the golfers that will be taking that round. Golfer profiles or other information may be included in such notifications or alerts. It can be appreciated that other types of alerts or notifications may be sent for different kinds of assets and amenities.

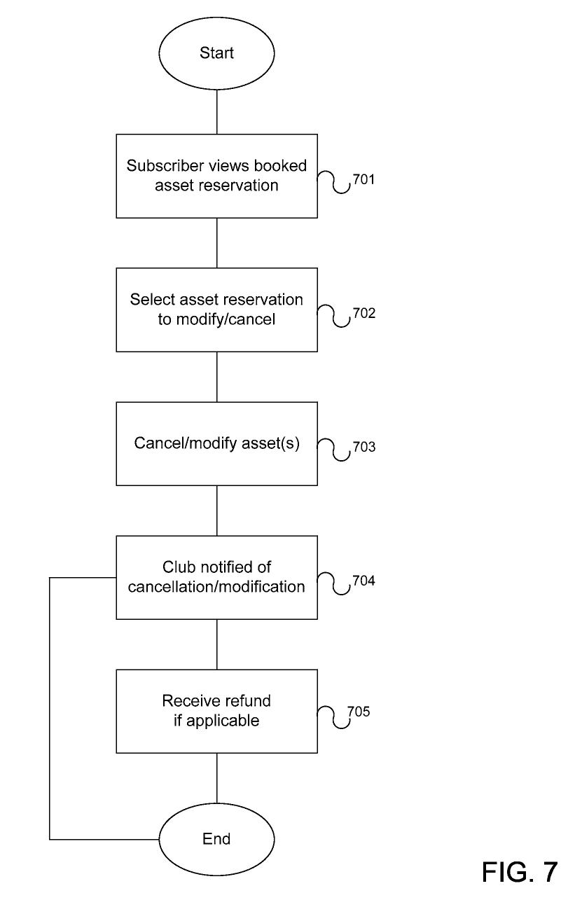

Referring to FIG. 7, individual subscribers may also cancel or modify a previously booked asset, which may or may not result in a refund to the individual subscriber. The individual subscriber may view a list of upcoming, booked assets in step 701, then select an asset reservation to cancel or modify in step 702, and the cancellation or modification may occur in step 703. For example, a golfer may cancel a previously booked tee time. Or, a golfer may change the members of the golfing party, or the names of the golfers or the players who will be playing a certain round with him or her. The club may be notified of the cancellation or modification in step 704. If the user is cancelling an asset in which the last time to cancel has not passed, then the user may receive a refund in step 704. If the user is cancelling an asset in which the last time to cancel has passed, then the user may not receive a refund. In addition, various alerts or confirmation messages may be sent. For example, if a tee time is cancelled or modified, a confirmation message may be sent to the booking golfer as well as the other members of the golfing party as well.

In one embodiment of the present invention, the asset reservation capability may be offered through the single, self-service web interface and may be realized by real-time data that is provided or uploaded from participating private club facilities. Data may be managed by private club facilities locally and updated as new information becomes available. Alternatively, data may be managed by a more central data storage, such as data storage 104 shown in FIG. 1. In some embodiments, an individual subscriber may browse the library of participating private club facilities and available assets, which are both current and live, by logging onto a web site at any convenient time. A subscriber may search by desired private club, or desired time of reservation. For example, for golf courses, the search may be separated by regions, states, cities, or areas within any of these, and available tee times for each may be shown. When desired tee times are selected, the desired tee time may be purchased or reserved by the subscriber. Any number of golf facilities (golf courses), including those normally exclusive to private members, may be incorporated into the system. Similarly, any type of asset, including those normally exclusive to private club members, may be incorporated into the system. While the private club is able to conduct business normally without interruption, an individual subscriber desiring to reserve an asset may log onto the website from an available remote location such as from their home, office, mobile device, etc. and browse various private clubs and available assets and amenities.

The ability for an individual subscriber to schedule assets through a single, self-service web interface is reflected in the steps illustrated in FIG. 6. With many private club managers participating, individual subscribers may be privileged to assets on many private clubs across town, around the country, and even overseas, where they otherwise would not have access. Therefore, there is the ability to gain access to private clubs through member-to-member reciprocity, even when the club has not posted an asset.

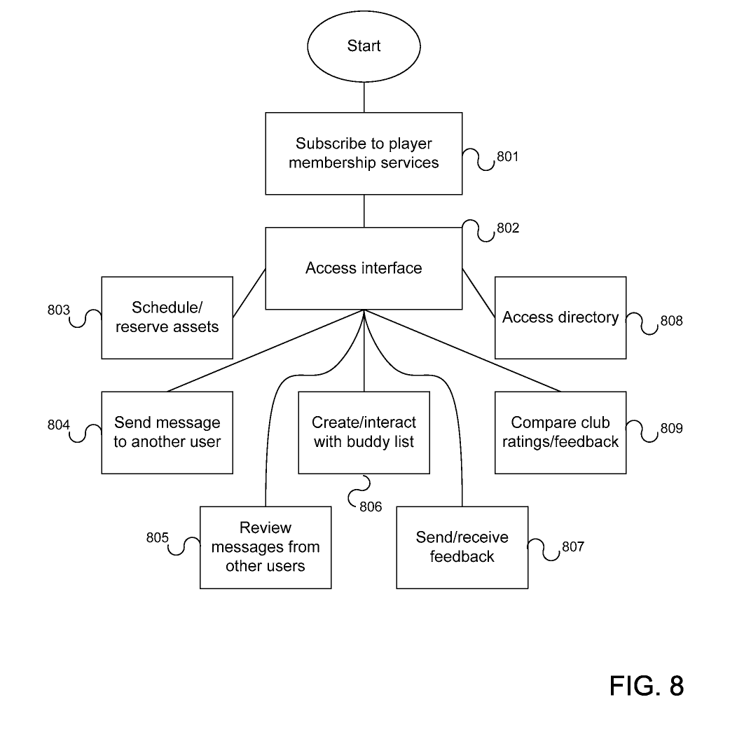

Referring to FIG. 8, after an individual user subscribes to membership services in step 801, and logs on to the interface (which may be a web interface) in step 802, the user may schedule or reserve assets in step 803, as described above. In addition, users may take advantage of increased business and social networking opportunities, in many ways by networking with other users. For example, the members may start discussions with other users on chats or forums hosted by the interface, or may send a direct message to other users in step 804. Or, the users may exchange contact information and agree to meet at a certain private club, or elsewhere. Users may also review messages received from other users in step 805.

In step 806, individual subscribers may create a “Buddy List” or message distribution list. Individual subscribers may be able to send messages to other subscribers on their message distribution list. For example, when brokering tee times for private golf clubs, a golfer may be able to create a consistent playing party (foursome) and send messages to those other players about potential tee times. Golfers may maintain several message distribution lists, and messages sent to a certain distribution list may be delivered to all members of that distribution list. In addition, in step 807, golfers may be able to leave feedback on their play experience at a certain club, or rate their play experience with other golfers. Golfers may be able to review and dispute feedback left about them as well. Golfers may also access the network's directory and mailing list and other information in step 808. For example, a golfer may be able to review a club's profile, or may search for other golfer's based on region, name, handicap, play speed, club membership or other public attributes. Golfers may also be updated or notified about course conditions (posted by either clubs or players) or be able to browse or search for this data through the interface. It can be appreciated that different aspects of embodiments of this invention as described can be applied to other types of assets and private clubs, in addition to the private golf clubs and tee times as described herein.

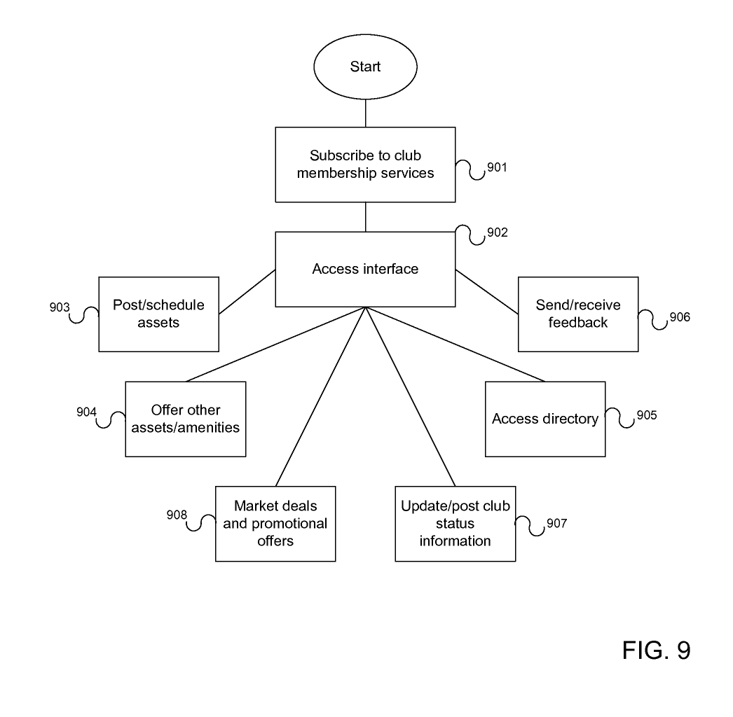

Referring to FIG. 9, after an institutional user subscribes to club membership services in step 901, and logs on to the interface (which may be a web interface) in step 902, the user or club may post or schedule assets in step 903, as described above. A club may also access information available in the network's directory 905, such as contact information of certain individual subscribers (if the individual subscribers make that information publicly available) or other profile information about certain subscribers. For example, a private golf club may be able to search for and view individual golfers based on a region, name, handicap, play speed, club membership or other data that is available publicly. Clubs may also search through and view profiles of other clubs as well. Clubs may use this information from the directory to market targeted deals and promotional offers (908), or may market deals and promotional offers generally as well, as further described below.

In addition, clubs may be able to send and receive feedback 906. For example, private golf clubs may leave feedback about the play of golfers that have played at their clubs, and may receive feedback from golfers about their experience at a particular club. Club personnel may also be able to review feedback left for themselves as well as feedback left for other members and clubs. They may also have the ability to dispute poor feedback. In addition, for example, a private golf club may also be able to update or post course conditions 907, for example, if an overseeding of a fairway is observed. Golfers may be able to view this information while browsing potential tee times or when confirming upcoming tee times. Golfers may also receive notifications based on updates made to the course conditions. It can be appreciated that the same types of notifications, updates, and feedback may be applied to different types of assets or private clubs, such as private hunting clubs, yachting clubs, athletic clubs, etc.

In each of the embodiments described herein, the interface may capture not only information about private clubs, but information about the individual subscribers themselves. The interface may store and make accessible subscriber's profiles, preferences and feedback, which may support and promote a positive experience for all parties. For example, for golf clubs and golfers, the interface may require all users to become members of the Golf Handicap and Information Network (GHIN) or another similar handicapping organization. Or, in addition, the interface may also publish and host standards for etiquette so that such standards are available to its subscribers.

In addition, private clubs may maintain the exclusivity of their members by controlling the reservations of certain assets. For example, a private golf club may maintain exclusivity by controlling or restricting the numbers of rounds played by the subscribers at their course within a given month, year, lifetime, etc. Further, tee times may be limited to specific member types, different levels of membership, play speeds, player feedback scores, or other measurements. Public golf courses utilizing the system may enforce similar rules. Policies may also be put into place for cancellations or exceptions. For example, the interface may require prepayment, alert parties when there are cancellations or delays or may initiate a rescheduling process for weather-based cancellations.

In addition, various assets may be made available with certain customized features, which can meet the unique needs of a private club. For example, for private golf clubs, tee times can reflect a 9-hole or an 18-hole golf course. Other items that may be customized for private golf clubs include the interval between tee times at various times during the day, the number of players allowed in a group, the facility opening and closing hours by day of the week, a description of course policies, or lists of golfer e-mail addresses for automated notifications. It can be appreciated that the same types of customized features can be applied to other types of assets and private clubs, in addition to private golf clubs and tee times.

Another potential function of the interface is to present and market deals and promotional offers (908). For example, golf equipment vendors may utilize the interface to make targeted and relevant equipment deals and promotional offers to potential customers. Private golf clubs or public courses may offer its customers food and beverage discounts, or discounts in equipment bought in the pro shop. In addition, golf instructors may offer or post times for lessons, clinics or open practice times, and other users may sign-up for such lessons or clinics through the interface (904). It can be appreciated that such market deals and promotional offers may be applied to hunters for hunting clubs, members of athletic clubs, tennis players for tennis clubs, etc.

A network and community of committed, affluent individuals may subscribe to the interface, making targeted marketing even more effective. For example, for a golfing community, relevant and precise marketing campaigns may be created based on subscriber's profiles which may include demographics such as (i) the member's type, gender, age, skill level, etc., (ii) equipment (clubs, golf balls, shoes, etc.) and (iii) geography (address information of the golfer). The directory information aggregated from information about subscribers may also be very valuable and an additional source of revenue (905). In addition, the interface may create more opportunities for virtual or regional promotions, or partnership opportunities with other large online communities. The community may also utilize forums, chats, discussions and blogs to further foster their relationships. For example, for a golf community, players may also compare courses, their own skill levels, their own performance on certain courses, or other statistics.

In certain embodiments of the invention, individual subscribers may have all of the capabilities of institutional subscribers to the system, in that an individual subscriber may also have the ability to post assets and engage in other functions or activities of institutional subscribers as described above, thus becoming hosting subscribers. Thus, the particular descriptions of actions and functions of institutional subscribers in reference to private clubs is not limited but may be applied to individual subscribers as well. In addition, a club manager or other club personnel with institutional subscriptions may have the ability to engage in functions of individual subscribers, so the particular descriptions of actions and functions of individual subscribers in reference to individuals may be applied to private clubs, other types of corporate entities or other institutional subscribers as well.

In tougher economic times, when private clubs may have difficulty with funding due to economy-related membership attrition, membership losses resulting from increased assessments, and overall revenue shortfalls, a marketplace for trading available assets and amenities and the creation of the online community as described may help private clubs endure economic downturns. Further, certain embodiments of the present invention provide for a centralized interface for private clubs to offer assets and amenities to potential new members. Through the interface, private clubs and other institutional subscribers may gain new members. Private clubs may provide information about the club via the interface (e.g., through profile information or by providing links to the private clubs' website). In addition, by offering assets, amenities, discounts or other services as described above, private clubs may be able to offer individual subscribers the opportunity to test drive their services, assets, amenities and other facilities, before committing to private club membership fees.

Embodiments of the present invention provide for minimal financial investment in the web interface with maximum optionality. Revenue may be generated from sale of mailing lists of members, percentages of sales of assets, food and beverage sales, related amenity sales, or other services sold through the site. The interface may offer the ability to post unused asset inventory in a simple, orderly manner to a controlled audience, and thus creates an interface to broker under-utilized assets and amenities. In addition, the interface may enable peer-to-peer networking by allowing its users to communicate with one another, and the interface may also facilitate targeted marketing. In addition, the interface may provide a wealth of information. For example, for a golf community, the interface may provide information including diagnostics on course play, trends for tee time utilization, individual user profiles and statistics, and other information.

All concepts of the invention may be incorporated or integrated with other systems and methods for reserving tee times, including but not limited to those described in U.S. Pat. No. 7,249,041 (Last) issued on Jul. 24, 2007, which is hereby incorporated by reference in its entirety. In addition, all concepts of the invention may be incorporated or integrated with other features for golfing applications, including but not limited to those described in PCT/US00/10086 (Cotton et. al) filed on Apr. 14, 2000, which is hereby incorporated by reference in its entirety.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. An asset exchange platform for brokering assets of private clubs comprising:
an asset manager for posting available assets of at least one private club;
a profile manager for keeping profile information of private club members and subscribers of the asset exchange platform;
a database for storing information relating to assets, member profile information, subscriber profile information, and transaction data;
wherein subscribers of the asset exchange platform can request and make reservations for available assets.

2. The asset exchange platform of claim 1, wherein the subscribers are private club members.

3. The asset exchange platform of claim 1, wherein the private club is a private golf club.

4. The asset exchange platform of claim 3, wherein the available assets are available tee times.

5. The asset exchange platform of claim 1, wherein the subscribers of the asset exchange platform pay a subscription fee.

6. The asset exchange platform of claim 1, wherein the subscribers of the asset exchange platform pay a booking fee when making reservations for available assets.

7. The asset exchange platform of claim 1, wherein the subscribers of the asset exchange platform access the asset exchange platform through the Internet.

8. The asset exchange platform of claim 1, wherein available assets of the private club are made available to subscribers who are not members of the private club.

9. The asset exchange platform of claim 1, wherein at least one subscriber is a manager of a private club.

10. The asset exchange platform of claim 1, wherein reservations for available assets may only be made by subscribers who meet pre-determined criteria established by the private club.

11. The asset exchange platform of claim 1, wherein the database is used for targeted advertising.

12. A method for brokering assets of private clubs over an asset exchange platform comprising:
receiving information for at least one available asset of at least one private club;
making the at least one asset viewable for a subscriber of the asset exchange platform;
receiving a request for an asset reservation from a subscriber of the asset exchange platform;
storing profile information of the subscriber; and
confirming the asset reservation request for the at least one available asset at the private club,
wherein the subscriber is not a member of the private club and the asset exchange platform facilitates exchange of the at least one available asset that would not otherwise be utilized by members of the private club.

13. The method of claim 12, wherein the asset reservation is confirmed only if the subscriber meets pre-determined criteria established by the private club.

14. The method of claim 12, wherein the at least one available asset is a tee time at a private golf club.

15. The method of claim 12, wherein the at least one asset is made available only to a pre-determined set of subscribers.

16. The method of claim 12, wherein the at least one asset is made available only to subscribers who meet a pre-determined set of criteria.

17. The method of claim 12, further comprising alerting the subscriber when an asset of a private club matching the request from the subscriber becomes available.

18. The method of claim 12, wherein the information for assets is received by a member of the private club.

19. The method of claim 12, further comprising keeping a history of asset reservations for each subscriber.

20. A computer readable medium comprising computer executable instructions adapted to perform a method for brokering under-utilized assets of private clubs over an asset exchange platform comprising:
receiving information for assets of at least one private club;
receiving a request for an asset from a subscriber of the asset exchange platform;
making at least one asset available for a subscriber of the asset exchange platform;
storing profile information of the subscriber; and
confirming a reservation for the at least one available asset at a private club,
wherein the subscriber is not a member of the private club and the asset exchange platform facilitates exchange of under-utilized assets.
